(19) United States
(12) Patent Application Publication
(10) Pub. No.: US 2011/0285973 A1
(43) Pub. Date: Nov. 24, 2011

(54) PROJECTION OPTICAL APPARATUS

(75) Inventor: Takayoshi TOGINO, Koganei-shi (JP)

(73) Assignee: OLYMPUS CORPORATION, Tokyo (JP)

(21) Appl. No.: 13/105,277

(22) Filed: May 11, 2011

(30) Foreign Application Priority Data
May 18, 2010 (JP) 2010-114112

(51) Int. Cl. G03B 21/28

(52) U.S. Cl. 353/98

(57) ABSTRACT

The projection optical apparatus of the invention comprises a projection optical system 13 for projection of an image displayed on a two-dimensional image display device 13b; a cylindrical screen 11 which is decentered with respect to the projection optical system 13 and onto which an image projected from the projection optical system 13 is projected; and a correction optical system 12 including an optical device 12a that has different powers in the direction (Y-axis direction) of the center axis of rotation of the cylindrical screen 11 and in the direction (X-axis direction) orthogonal to a first plane 101 including a center chief ray C of a light beam traveling from the projection optical system 13 toward the cylindrical screen 11.

### BACKGROUND OF THE INVENTION

The present invention relates generally to an optical system set up with a projection optical system built in it, and more specifically to an projection optical apparatus capable of projecting high-resolution images onto a cylindrical projection surface (screen) without image distortion.

Referring to projection optical systems that use a projector system to project real images onto a cylindrical screen, JP(A) 2007-334019 discloses a small-format optical system capable of projecting an image having a full 360 degree azimuth angle of view with reduced flare light and improved resolving power.

### SUMMARY OF THE INVENTION

According to one embodiment of the invention, there is a projection optical apparatus provided, which comprises a projection optical system for projection of an image displayed on a two-dimensional image display device, and a cylindrical screen which is decentered with respect to the projection optical system and on which an image projected from the projection optical system is projected. Preferably in this embodiment, the projection optical apparatus should further comprise a correction optical system including an optical device that has different powers in a direction (Y-axis direction) of the center axis of rotation of the cylindrical screen and in a direction (X-axis direction) orthogonal to a first plane including a center chief ray of a light beam traveling from the projection optical system toward the cylindrical screen.

In one preferable embodiment of the invention, the optical device having different powers in the Y-axis and X-axis directions should be a cylindrical mirror.

In another preferable embodiment of the invention, the correction optical system should comprise a first optical device having different powers in the Y-axis and X-axis directions, and a second optical device that is rotationally asymmetric about an optical axis for correction of astigmatism produced at the first optical device.

In a further preferable embodiment of the invention, the cylindrical screen should have an arc angle of 30° or greater.

In a further preferable embodiment of the invention, the angle of the center chief ray projected onto the center of projection of the cylindrical screen should be 10° or greater.

In a further preferable embodiment of the invention, the following Condition (1) should be satisfied.

Rr<500 (1)

Here Rr is the radius of curvature in the horizontal direction of the cylindrical mirror.

In a further preferable embodiment of the invention, the following Condition (2) should be satisfied.

2<Rs/Rr (2)

Here Rs is the radius of curvature of the screen, and Rr is the radius of curvature in the horizontal direction of the cylindrical mirror.

Still other objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is illustrative of a coordinate system for, and the first plane, in one embodiment of the invention.

FIG. 2 is illustrative of a coordinate system for, and the second place, in one embodiment of the invention.

FIG. 3 is illustrative in the YZ plane section of the optical system of Example 1, and its peripherals.

FIG. 4 is illustrative on the ZX plane of the optical system of Example 1, and its peripheral arrangement.

FIG. 5 is a transverse aberration diagram for the whole optical system of Example 1.

FIG. 6 is a transverse aberration diagram for the whole optical system of Example 1.

FIG. 7 is indicative of image distortions throughout the optical system of Example 1.

FIG. 8 is illustrative in the YZ plane section of the optical system of Example 2, and its peripherals.

FIG. 9 is illustrative on the ZX plane of the optical system of Example 2, and its peripherals.

FIG. 10 is a transverse aberration diagram for the whole optical system of Example 2.

FIG. 11 is a transverse aberration diagram for the whole optical system of Example 2.

FIG. 12 is indicative of image distortions throughout the optical system of Example 2.

FIG. 13 is illustrative in the YZ plane section of the optical system of Example 3, and its peripherals.

FIG. 14 is illustrative on the ZX plane of the optical system of Example 3, and its peripherals.

FIG. 15 is a transverse aberration diagram for the whole optical system of Example 3.

FIG. 16 is a transverse aberration diagram for the whole optical system of Example 3.

FIG. 17 is indicative of image distortions throughout the optical system of Example 3.

FIG. 18 is illustrative in the YZ plane section of the optical system of Example 4, and its peripherals.

FIG. 19 is illustrative on the ZX plane of the optical system of Example 4, and its peripherals.

FIG. 20 is a transverse aberration diagram for the whole optical system of Example 4.

FIG. 21 is a transverse aberration diagram for the whole optical system of Example 4.

FIG. 22 is indicative of image distortions throughout the optical system of Example 4.

FIG. 23 is illustrative in the YZ plane section of the correction optical system in a further embodiment of the invention, and its peripherals.

FIG. 24 is illustrative on the ZX plane of the correction optical system in a further embodiment of the invention, and its peripherals.

FIG. 25 is illustrative in the YZ plane section of the correction optical system in a further embodiment of the invention and its peripherals as well as of how images are viewed by the viewer.

### DESCRIPTION OF EXEMPLARY EMBODIMENTS

The inventive projection optical apparatus is now explained with reference to examples.

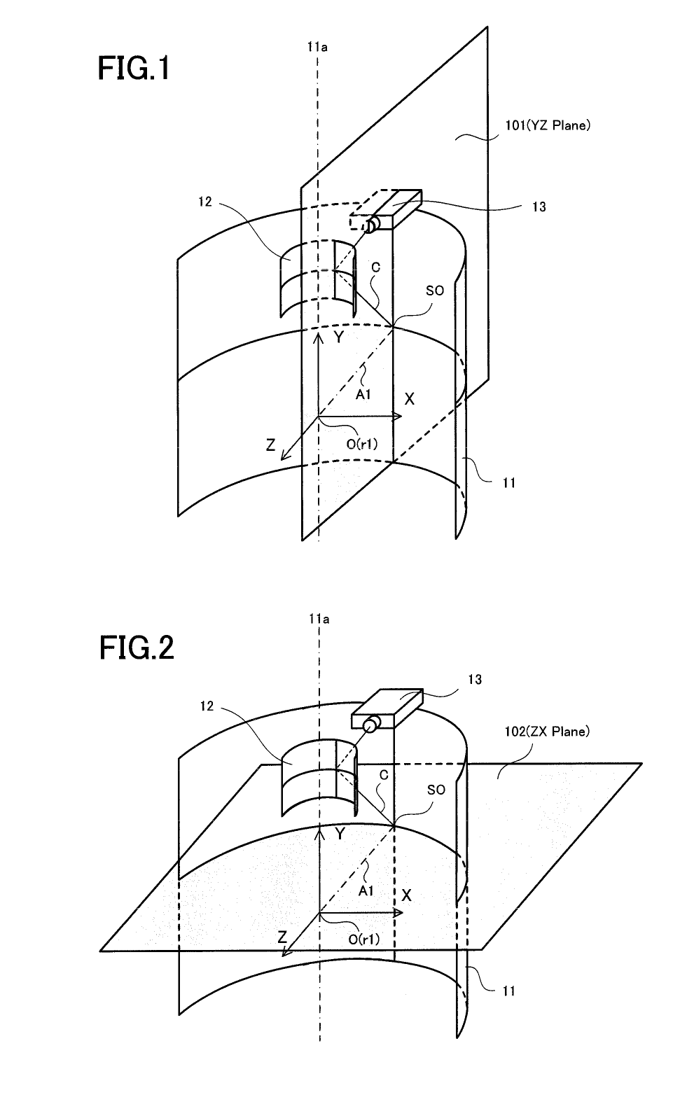

First of all, the coordinate system for one embodiment is explained. FIG. 1 is illustrative of the coordinate system for, and the first plane, in one embodiment of the invention, and FIG. 2 is illustrative of the coordinate system for, and the second plane, in the embodiment.

As shown in FIGS. 1 and 2, the projection optical apparatus incorporating the optical system of this embodiment comprises a projection optical system 13, a correction optical system 12 and a cylindrical screen 11. An image projected from the projection optical system 13 is reflected at the correction optical system 12 such as a cylindrical mirror and projected onto the cylindrical screen 11.

Referring to the coordinate system for the optical system here, the center of projection SO is defined by a point of intersection of a center chief ray C leaving the projection optical system 13 with the cylindrical screen 11 via the correction optical system 12, and the origin O is defined by a point of intersection of the center axis of rotation 11a with a perpendicular A1 drawn from the center of projection SO to the center axis of rotation 11a of the cylindrical screen 11.

As shown in FIG. 1, the first surface 101 is defined by a surface that includes the center axis of rotation 11a of the cylindrical screen 11 and the center chief ray C, and as shown in FIG. 2, the second surface 102 is defined by a surface that is orthogonal to the center axis of rotation 11a of the cylindrical screen 11 and includes the center of projection SO. Further, the first surface 101 is defined as the YZ plane and the second surface 102 is defined as the ZX plane so that the XYZ coordinate can be defined.

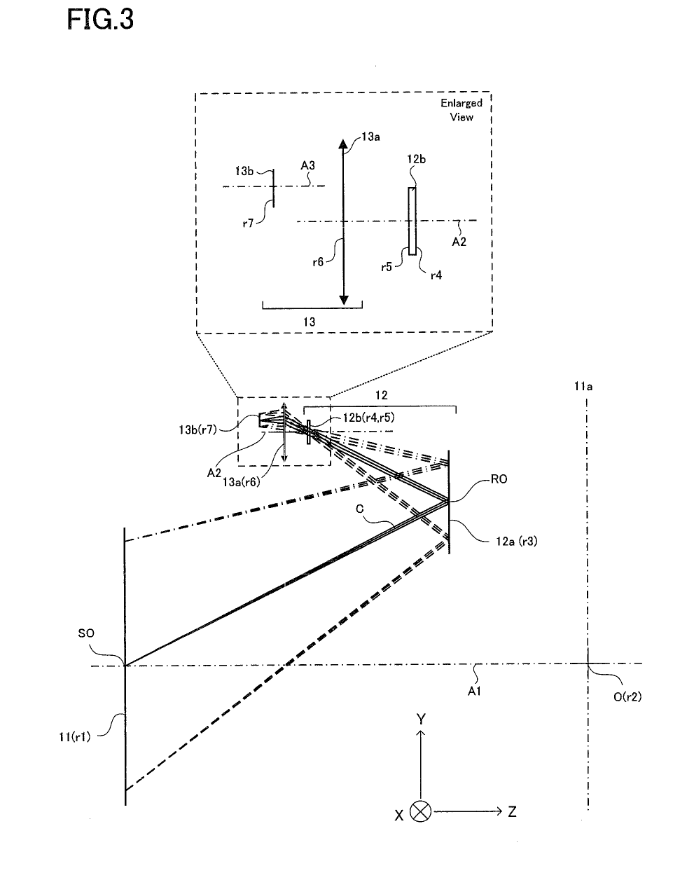

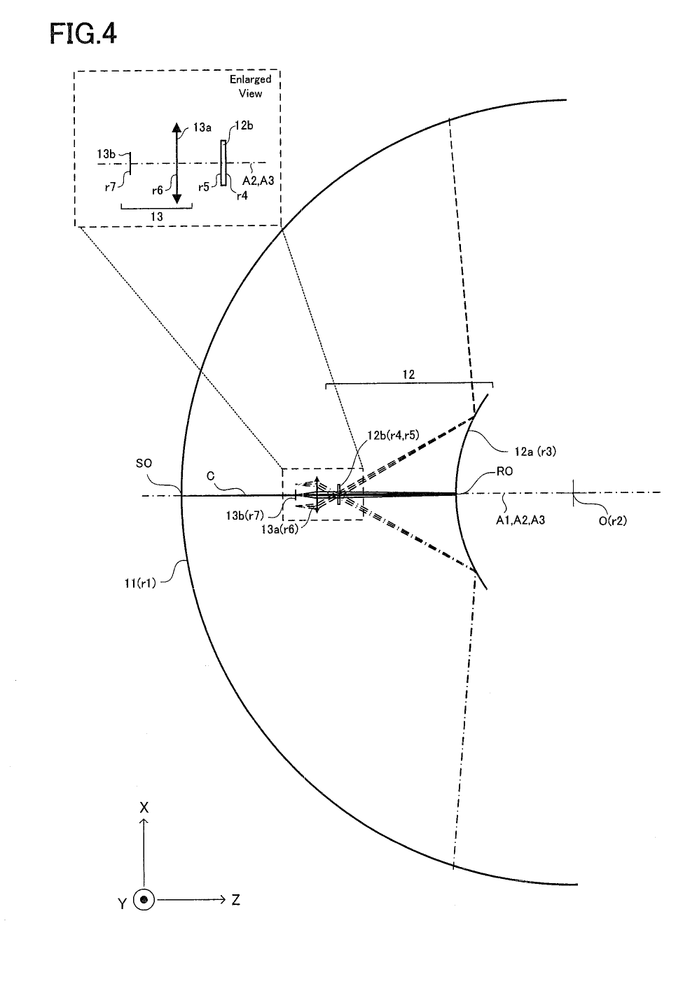

The projection optical apparatus according to the embodiment here is now explained with reference to Example 1. FIG. 3 is illustrative in the YZ plane section of the optical system of Example 1 and its peripherals, and FIG. 4 is illustrative on the ZX plane of the optical system of Example 1 and its peripherals.

The projection optical apparatus according to the embodiment here comprises a projection optical system 13 such as a projector for projecting an image displayed on a two-dimensional image display device 13b through an ideal lens 13a and a cylindrical screen 11 which is decentered with respect to the projection optical system 13 and onto which an image projected from the projection optical system 13 is projected, and further comprises a correction optical system 12 having optical devices 12a and 12b having different powers (refracting powers) in the direction (Y-axis direction) of the center axis of rotation 11a of the cylindrical screen 11 and in the direction (X-axis direction) that is orthogonal to the first plane 101 including the center chief ray C of a light beam traveling from the projection optical system 13 toward the cylindrical screen 11.

An image is projected in an oblique direction because the projection optical system 13 and the cylindrical screen 11 remain decentered. Here the direction of the center axis of rotation 11a of the cylindrical screen 11 is defined as the Y-axis direction, and the direction that is orthogonal to the first plane 101 including the center chief ray C of a light beam traveling from the projection optical system 13 toward the cylindrical screen 11 is defined as the X-axis direction. A segment of the image projected from the projection optical system and lying parallel with the X-axis direction is going to strike upon the projection surface or cylindrical screen 11 in such a way as to cross the cylinder obliquely. A linear image lying horizontal on the image display device 13b is going to be curved for projection onto the cylindrical screen 11.

At least one optical device 12a having different powers (refracting powers) in the direction (Y-axis direction) of the center axis of rotation 11a of the cylindrical screen 11 and in the direction that is orthogonal to the first plane 101 including the center chief ray C of a light beam traveling from the projection optical system 13 toward the cylindrical screen 11 is used and decentered whereupon there is curved image distortion produced. The projection optical system according to the embodiment here makes use of such curved image distortion thereby making successful correction of curved image distortion produced at the time when an image is obliquely projected onto the cylindrical screen 11.

It is therefore possible to provide a projection optical apparatus capable of, in simplified construction, projecting an image on a planar image display device onto a cylindrical projection surface (cylindrical screen) with no image distortion yet with high resolution.

Preferably, the optical device having different powers in the Y-axis and X-axis directions should be a cylindrical mirror 12a.

Constructing the optical device from the reflecting surface would obviate chromatic aberrations, and greatly reduce other aberrations as well.

the correction optical system 12 should include a first optical device 12a having different powers in the Y-axis and X-axis directions, and a second optical device 12b that is rotationally asymmetric about the optical axis for correction of astigmatism produced at the first optical device 12a.

If astigmatism is corrected by the second optical device 12b that is rotationally asymmetric about the optical axis for correction of astigmatism produced at the first optical device 12a having different powers in the Y-axis and X-axis directions, it is then possible to view a projected image of high resolution. For the optical device that is rotationally asymmetric about the optical axis, use may be made of a cylindrical lens, a free-form surface lens, a free-form surface mirror, an axially symmetric free-form surface or the like. More preferably, if correction is implemented using higher-order terms of the free-form surface, it is then possible to project images of ever higher resolution.

Preferably, the cylindrical screen should have an arc angle of 30° or greater. At an arc angle of 30° or greater, curved image distortion grows so large that there is a visual sense of discomfort ending up with more effective correction by the correction optical system 12.

Preferably, the angle at which the center chief ray is projected to the center of projection SO of the cylindrical screen 11 should be 10° or greater. At an angle of 10° or greater, curved image distortion grows so large that there is a visual sense of discomfort ending up with more effective correction by the correction optical system 12.

Preferably, the following Condition (1) should be satisfied.

Rr<500 (1)

Here Rr is the radius of curvature in the horizontal direction of the cylindrical mirror.

Exceeding the upper limit to Condition (1) would render it impossible to increase the rate of enlargement of the screen in the horizontal (X-axis) direction, resulting in the inability to make the horizontal angle of view wide.

Preferably, the following Condition (2) should be satisfied.

2<Rs/Rr (2)

Here Rs is the radius of curvature of the screen, and Rr is the radius of curvature in the horizontal direction of the cylindrical mirror.

Falling short of the lower limit to Condition (2) would give rise to a decrease in the rate of enlargement of the image projected in the horizontal (X-axis) direction, resulting in the inability to implement wide angle-of-view projection.

An example of the optical systems for the projection optical apparatus 1 is now explained. The constituting parameters of these optical systems will be given later. The constituting parameters in these examples are traced by back ray tracing from the surface of the cylindrical screen 11 toward the image display device 13b.

Referring to the coordinate system involved, the center of projection SO is defined by a point at which the center chief ray C leaving the projection optical system 13 crosses the cylindrical screen 11 via the correction optical system 12, and the origin O of the decentered optical system is defined by a point of intersection of the center axis of rotation 11a with a perpendicular A1 drawn from the center of projection SO to the center axis of rotation 11a of the cylindrical screen 11. The Y-axis positive direction is defined by a direction of the center axis of rotation 11 from the origin O toward the projection optical system 13, and the Z-axis positive direction is defined by an opposite direction extending from the center of projection SO. And the X-axis positive direction is defined by an axis that makes a right-handed orthogonal coordinate system together with the Y-axis and Z-axis.

As shown in FIG. 1, the first plane 101 is defined by a plane including the center axis of rotation 11a of the cylindrical screen 11 and the center chief ray C, and as shown in FIG. 2, the second plane 102 is defined by a plane that is orthogonal to the center axis of rotation 11a of the cylindrical screen 11 and includes the center of projection SO. Further, the XYZ coordinate is defined with the first plane 101 as the YZ plane and the second plane 102 as the ZX plane.

Given to each decentered surface are the amount of decentration of the coordinate system having that surface defined thereon from the center of the origin of the optical system (X, Y and Z in the X-, Y- and Z-axis directions) and the angles (α, β, γ(°)) of tilt of the center axis of that surface with respect to the X-axis, the Y-axis, and the Z-axis of the coordinate system defined at the origin of the optical system, respectively. It is here noted that the positive α and β mean clockwise rotation with respect to the positive directions of the respective axes, and the positive γ means clockwise rotation with respect to the positive direction of the Z-axis. Referring to the α, β, γ rotation of the center axis of a certain surface, the coordinate system that defines each surface is first α rotated counterclockwise about the X-axis of the coordinate system defined at the origin of the optical system. Then, the rotated surface is β rotated counterclockwise about the Y-axis of a new coordinate system. Then, the twice rotated surface is γ rotated clockwise about the Z-axis of a new coordinate system.

When a specific surface of the optical function surfaces forming the optical system of each example and the subsequent surface form together a coaxial optical system, there is a surface separation given. Besides, the radius of curvature of each surface, and the refractive indices and Abbe constants of the media are given as usual. Coefficient terms, of no data are give in the parameters set out later, are zero. The refractive index and Abbe constants of the media are given on a d-line (587.56 nm wavelength) basis, and the otherwise unspecified length is given in mm.

The free-form surface used herein is defined by the following formula (a). Note here that the axis of the free-form surface is given by the Z-axis of that defining formula.

$$Z = ( {r}^{2} / R ) / [ 1 + \sqrt{ } \{ 1 - ( 1 + k ) {( r / R )}^{2} \} ] ∞ + {\sum }_{j = 1}^{∞} {C}_{j} {X}^{m} {Y}^{n} . \qquad ( a )$$

In formula (a) here, the first term is a spherical term and the second term is a free-form surface term.

In the spherical term,

R is the radius of curvature of the vertex,

k is the conic constant, and

r=√(X²+Y²).

The free-form surface term is

$${\sum }_{j = 1}^{66} {C}_{j} {X}^{m} {Y}^{n} = {C}_{1} + {C}_{2} X + {C}_{3} Y + {C}_{4} {X}^{2} + {C}_{5} XY + {C}_{6} {Y}^{2} + {C}_{7} {X}^{3} + {C}_{8} {X}^{2} Y + {C}_{9} {XY}^{2} + {C}_{10} {Y}^{3} + {C}_{11} {X}^{4} + {C}_{12} {X}^{3} Y + {C}_{13} {X}^{2} {Y}^{2} + {C}_{14} {XY}^{3} + {C}_{15} {Y}^{4} + {C}_{16} {X}^{5} + {C}_{17} {X}^{4} Y + {C}_{18} {X}^{3} {Y}^{2} + {C}_{19} {X}^{2} {Y}^{3} + {C}_{20} {XY}^{4} + {C}_{21} {Y}^{5} + {C}_{22} {X}^{6} + {C}_{23} {X}^{5} Y + {C}_{24} {X}^{4} {Y}^{2} + {C}_{25} {X}^{3} {Y}^{3} + {C}_{26} {X}^{2} {Y}^{4} + {C}_{27} {XY}^{5} + {C}_{28} {Y}^{6} + {C}_{29} {X}^{7} + {C}_{30} {X}^{6} Y + {C}_{31} {X}^{5} {Y}^{2} + {C}_{32} {X}^{4} {Y}^{3} + {C}_{33} {X}^{3} {Y}^{4} + {C}_{34} {X}^{2} {Y}^{5} + {C}_{35} {XY}^{6} + {C}_{36} {Y}^{7}$$

Here Cⱼ (j is an integer of 1 or greater) is a coefficient.

In general, the aforesaid free-form surface has no plane of symmetry at both the X-Z plane and the Y-Z plane.

However, by reducing all the odd-numbered degree terms for X down to zero, that free-form surface can have only one plane of symmetry parallel with the Y-Z plane. Referring typically to the above defining formula (a), this may be achieved by reducing down to zero the coefficients for the terms C₂, C₅, C₇, C₉, C₁₂, C₁₄, C₁₆, C₁₈, C₂₀, C₂₃, C₂₅, C₂₇, C₂₉, C₃₁, C₃₃, C₃₅, . . . .

By reducing all the odd-numbered degree terms for Y down to zero, the free-form surface can have only one plane of symmetry parallel with the X-Z plane. Referring typically to the above defining formula, this may be achieved by reducing down to zero the coefficients for the terms C₃, C₅, C₈, C₁₀, C₁₂, C₁₄, C₁₇, C₁₉, C₂₁, C₂₃, C₂₅, C₂₇, C₃₀, C₃₂, C₃₄, C₃₆, . . . .

If any one of the directions of the aforesaid plane of symmetry is used as the plane of symmetry and decentration is implemented in a direction corresponding to that, for instance, the direction of decentration of the optical system with respect to the plane of symmetry parallel with the Y-Z plane is set in the Y-axis direction, and the direction of decentration of the optical system with respect to the plane of symmetry parallel with the X-Z plane is set in the X-axis direction, it is then possible to improve productivity while, at the same time, making effective correction of rotationally asymmetric aberrations occurring from decentration.

The aforesaid defining formula (a) is given for the sake of illustration alone: the feature of the free-form surface here is that by use of the rotationally asymmetric surface having only one plane of symmetry, it is possible to correct rotationally asymmetric aberrations occurring from decentration while, at the same time, improving productivity. It goes without saying that the same advantages are achievable even with any other defining formulae.

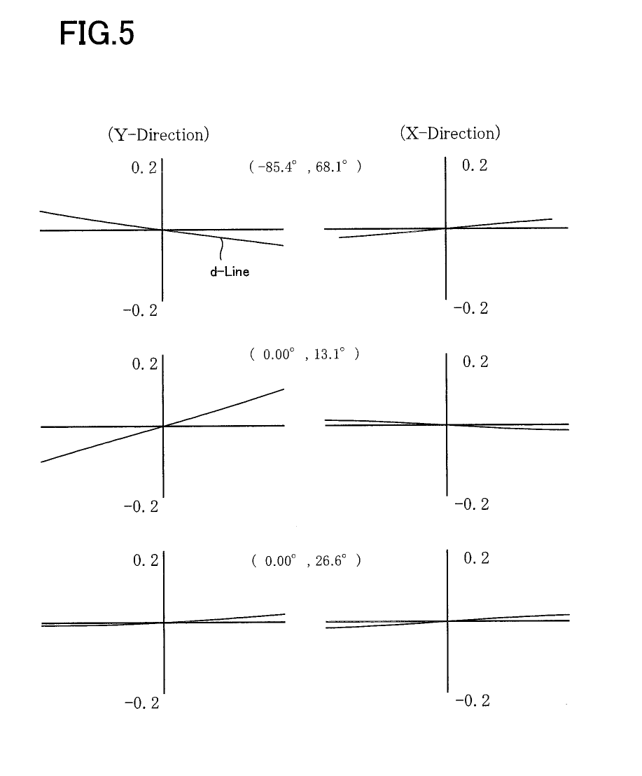

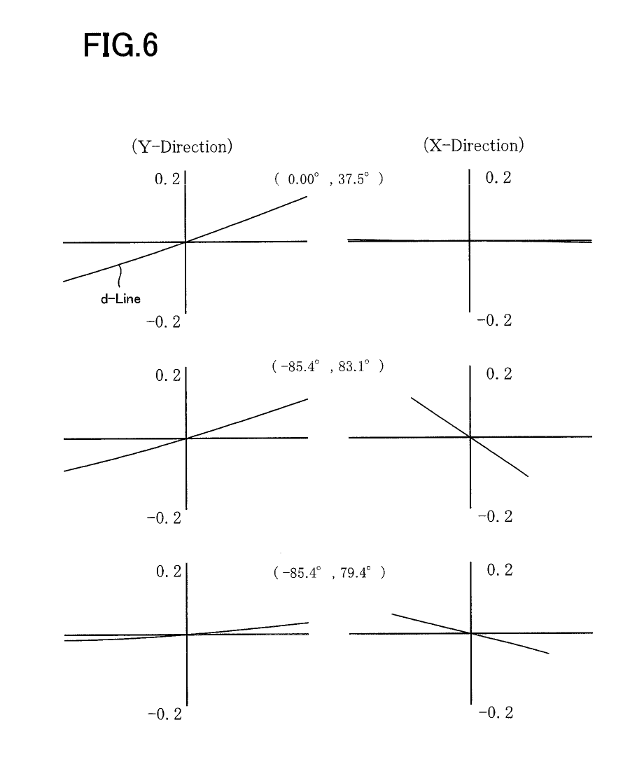

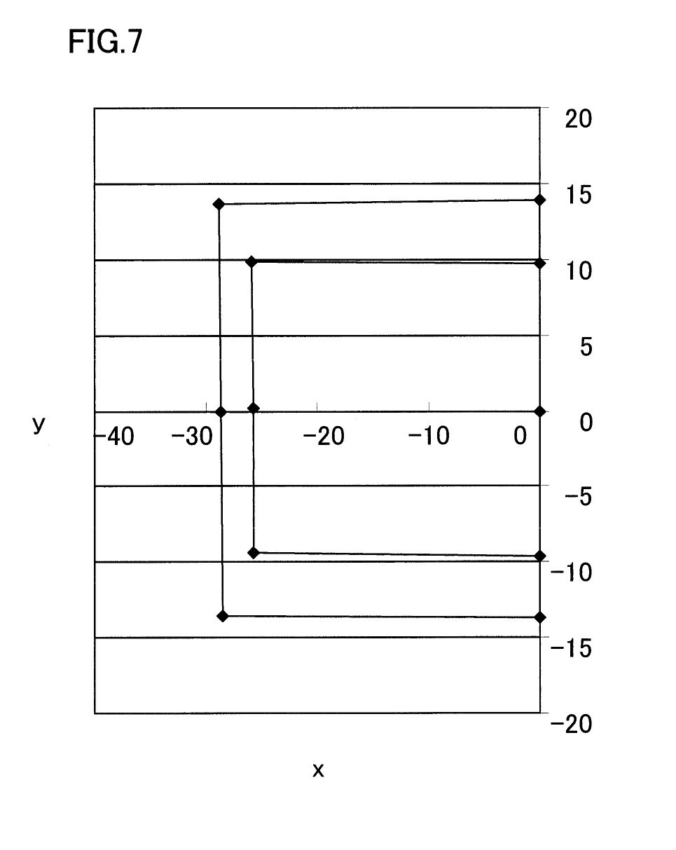

Example 1 is now explained. FIG. 3 is illustrative in the YZ plane section of the optical system of Example 1 and its peripherals, and FIG. 4 is illustrative on the ZX plane of the optical system of Example 1 and its peripherals. FIGS. 5 and 6 are transverse aberration diagrams for the whole optical system, and FIG. 7 is indicative of image distortions.

The projection optical apparatus of Example 1 is built up of a projection optical system 13 such as a projector for projecting an image displayed on a two-dimensional image display device 13b through an ideal lens 13a and a cylindrical screen 11 which is decentered with respect to the projection optical system 13 and onto which an image projected from the projection optical system 13 is projected, and further comprises a correction optical system 12 having a first optical device or cylindrical mirror 12a having different powers (refracting powers) in the direction (Y-axis direction) of the center axis of rotation 11a of the cylindrical screen 11 and in the direction (X-axis direction) that is orthogonal to a first plane 101 including the center chief ray C of a light beam traveling from the projection optical system 13 toward the cylindrical screen 11.

Further, the correction optical system 12 of Example 1 comprises a second optical device or cylindrical lens 12b that is rotationally asymmetric about an optical axis A2 for correction of astigmatism occurring at the cylindrical mirror 12a.

The cylindrical screen 11 is a reflecting surface that has a curvature in the ZX plane with the center axis of rotation 11a as center, and the cylindrical mirror 12a is a reflecting surface that is different in diametrical length from the cylindrical screen 11 and has a curvature in the ZX plane.

A line A1 that connects the center of projection SO of the cylindrical screen 11 with the coordinate origin O is decentered in the Y-axis direction with respect to the center axis A2 of the ideal lens 13a and the center axis A3 of the image display device 13b in the projection optical system 13. Suppose here that the center of reflection RO is defined by a point at which a center chief ray C is reflected off the cylindrical mirror 12a. The position of the center of reflection RO in the Y-axis direction is then located between the line A1 and the center axis A2 and between the line A1 and the center axis A3. Consequently, an image projected from the projection optical system 13 obliquely onto the cylindrical mirror 12a is reflected at the cylindrical mirror 12a and projected onto the cylindrical screen 11, providing a projected image that is to be viewed by a viewer.

Each of FIGS. 3 and 4 also presents an enlarged view of a site encircled by a broken line. The projection optical system 13 comprises an image display device 13b such as an LCD and an ideal lens 13a. A cylindrical lens 12b is provided with a stop at a cylindrical surface r4.

As shown in FIG. 3, the center axis A2 of the ideal lens 13a in the projection optical system 13 of Example 1 is decentered with respect to the center axis A3 of the image display device 13b. For this reason, an image emanating from the image display device 13b is projected through the periphery of the ideal lens 13a so that, just as is the case with use of a shift lens, it can be projected obliquely onto the decentered cylindrical mirror 12a.

Thus, oblique projection with the image display device 13b shifted and decentered is preferable because of no occurrence of distortion. Note here that with the projection optical system 13 tilted, there is a trapezoidal image distortion produced, but that may be electronically corrected.

Suppose here that the cylindrical mirror 12a (cylindrical reflecting surface) is used as the means for making the projection angle of view wide in the X-axis direction. However, the use of the cylindrical mirror 12a would result in the occurrence of astigmatism, giving rise to deterioration of the image formed on the cylindrical screen 11. That astigmatism here is corrected using the second optical device comprising the cylindrical lens 12b.

At the time of back ray tracing, a light beam leaving the cylindrical screen 11 (r1) as an object surface is reflected at the cylindrical mirror 12a (r3) in the correction optical system 12, and enters the cylindrical surface (r4) of the cylindrical lens 12b provided with the stop. Following this, a light beam transmitting through the cylindrical lens 12b and leaving the opposite surface (r5) enters the ideal lens 13a (r6) in the projection optical system 13. Then, a light beam leaving the ideal lens 13a (r6) arrives at a radially given position off the optical axis of the image display device 13b (r7). Note here that the coordinate origin O is indicated by r2.

In Example 1, the cylindrical screen 11 is defined by the inside of the cylindrical surface having a radius of 1 m with the origin O at the center position, and the ideal lens 13 has a focal length of 50 mm and an exit pupil diameter of 15 mm.

FIG. 7 is indicative of image distortions in Example 1. The outside, substantial quadrilateral stands for distortion at an image plane having the maximum image height, and the inside, substantial quadrilateral stands for distortion at an image plane of the maximum image height×0.7. It can be seen that the upper and lower sides of the substantial quadrilaterals draw close to horizontal, indicating that image distortions likely to be curved have been corrected.

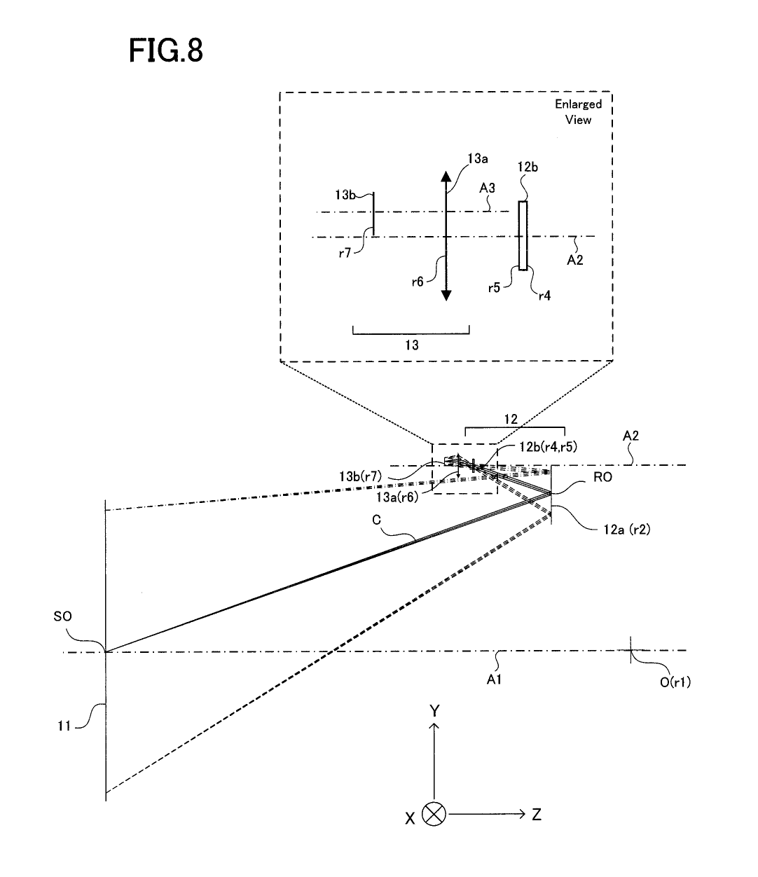

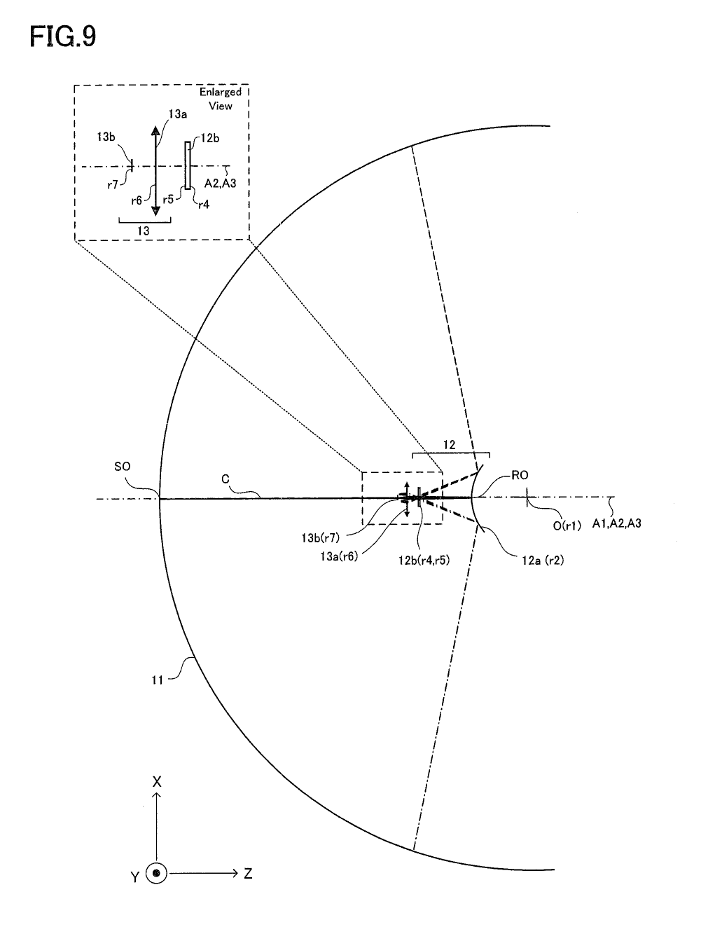

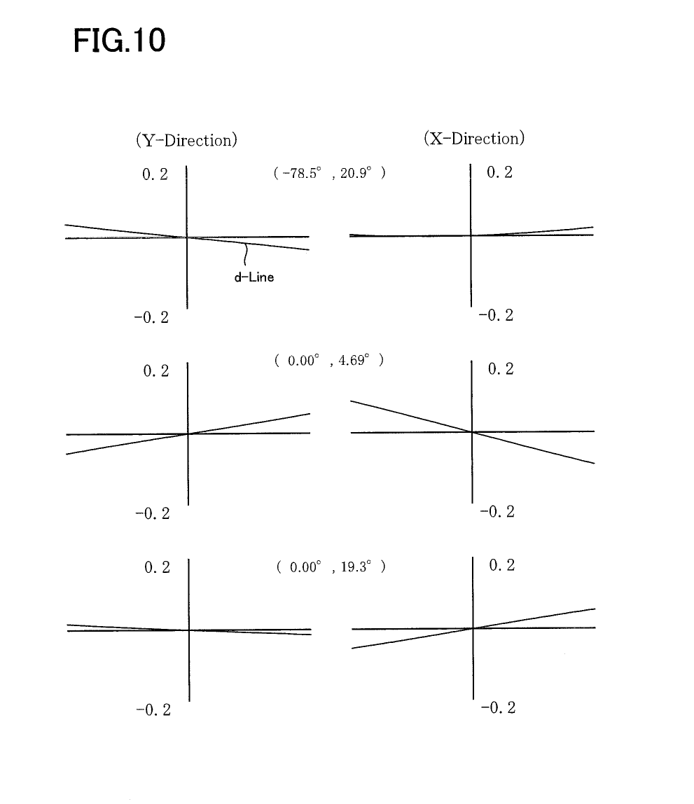

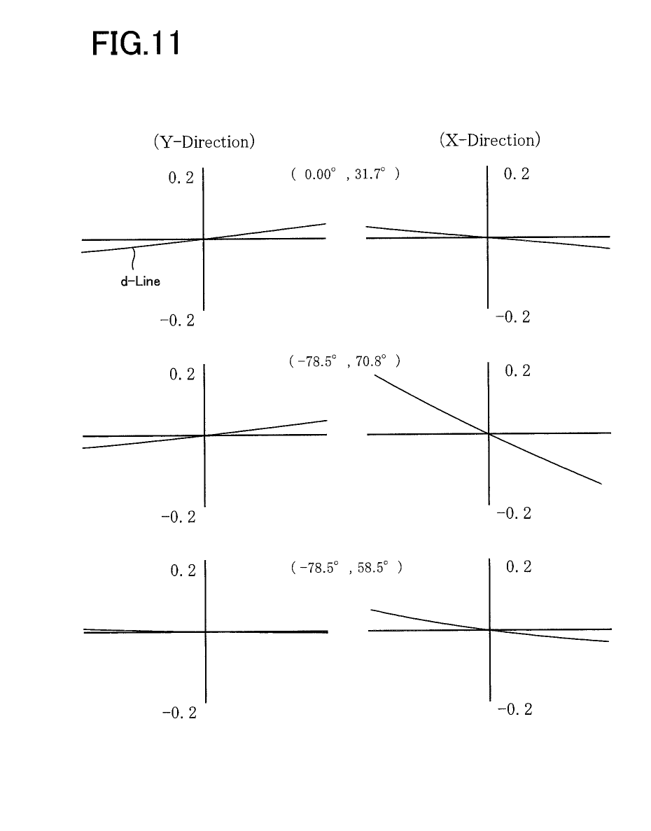

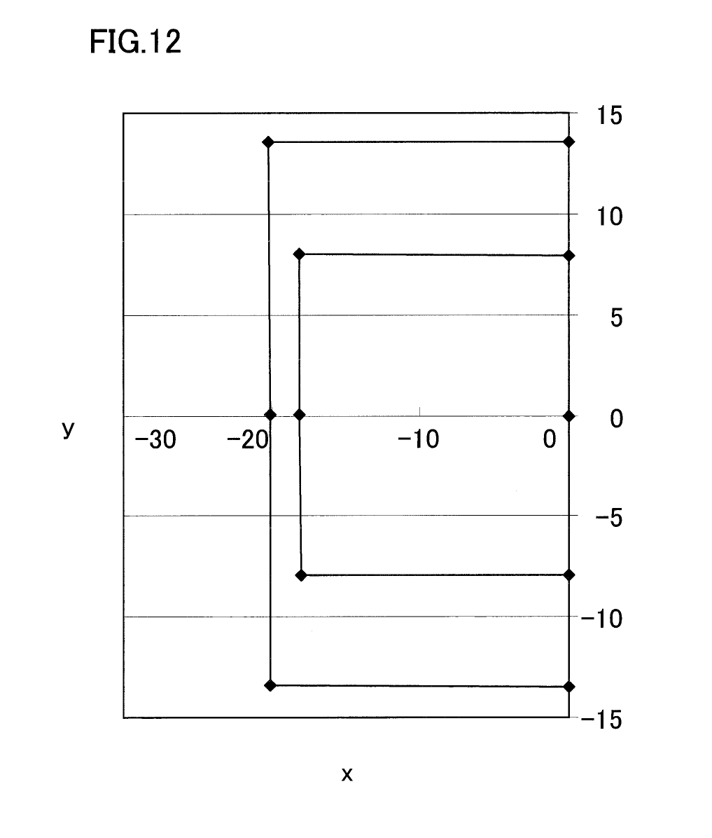

Example 2 is now explained. FIG. 8 is illustrative in the YZ plane section of the optical system of Example 2 and its peripherals, and FIG. 9 is illustrative on the ZX plane of the optical system of Example 2, and its peripherals. FIGS. 10 and 11 are transverse aberration diagrams for the whole optical system, and FIG. 12 is indicative of image distortions.

The projection optical apparatus of Example 2 is built up of a projection optical system 13 such as a projector for projecting an image displayed on a two-dimensional image display device 13b through an ideal lens 13a and a cylindrical screen 11 which is decentered with respect to the projection optical system 13 and onto which an image projected from the projection optical system 13 is projected, and further comprises a correction optical system 12 having a first optical device or cylindrical mirror 12a having different powers (refracting powers) in the direction (Y-axis direction) of the center axis of rotation 11a of the cylindrical screen 11 and in the direction (X-axis direction) that is orthogonal to a first surface 101 including the center chief ray C of a light beam traveling from the projection optical system 13 toward the cylindrical screen 11.

Further, the correction optical system 12 of Example 2 comprises a second optical device or cylindrical lens 12b that is rotationally asymmetric about an optical axis A2 for correction of astigmatism occurring at the cylindrical mirror 12a.

The cylindrical screen 11 is a reflecting surface that has a curvature in the ZX plane with the center axis of rotation 11a as center, and the cylindrical mirror 12a is a reflecting surface that is different in diametrical length from the cylindrical screen 11 and has a curvature in the ZX plane.

A line A1 that connects the center of projection SO of the cylindrical screen 11 with the coordinate origin O is decentered in the Y-axis direction with respect to the center axis A2 of the ideal lens 13a and the center axis A3 of the image display device 13b in the projection optical system 13. Suppose here that the center of reflection RO is defined by a point at which a center chief ray C is reflected off the cylindrical mirror 12a. The position of the center of reflection RO in the Y-axis direction is then located between the line A1 and the center axis A2 and between the line A1 and the center axis A3. Consequently, an image projected from the projection optical system 13 obliquely onto the cylindrical mirror 12a is reflected at the cylindrical mirror 12a and projected onto the cylindrical screen 11, providing a projected image that is to be viewed by a viewer.

Each of FIGS. 8 and 9 also presents an enlarged view of a site encircled by a broken line. The projection optical system 13 comprises an image display device 13b such as an LCD and an ideal lens 13a. A cylindrical lens 12b is provided with a stop at a cylindrical surface r4.

As shown in FIG. 8, the center axis A2 of the ideal lens 13a in the projection optical system 13 of Example 2 is decentered with respect to the center axis A3 of the image display device 13b. For this reason, an image emanating from the image display device 13b is projected through the periphery of the ideal lens 13a so that, just as is the case with use of a shift lens, it can be projected obliquely onto the decentered cylindrical mirror 12a.

Thus, oblique projection with the image display device 13b shifted and decentered is preferable because of no occurrence of distortions. Note here that with the projection optical system 13 tilted, there is a trapezoidal image distortion produced, but that may be electronically corrected.

Suppose here that the cylindrical mirror 12a (cylindrical reflecting surface) is used as the means for making the projection angle of view wide in the X-axis direction. However, the use of the cylindrical mirror 12a would result in the occurrence of astigmatism, giving rise to deterioration of the image formed on the cylindrical screen 11. That astigmatism here is corrected using the second optical device comprising the cylindrical lens 12b.

At the time of back ray tracing, a light beam leaving the cylindrical screen 11 (r1) as an object surface is reflected at the cylindrical mirror 12a (r3) in the correction optical system 12, and enters the cylindrical surface (r4) of the cylindrical lens 12b provided with the stop. Following this, a light beam transmitting through the cylindrical lens 12b and leaving the opposite surface (r5) enters the ideal lens 13a (r6) in the projection optical system 13. Then, a light beam leaving the ideal lens 13a (r6) arrives at a radially given position off the optical axis of the image display device 13b (r7). Note here that the coordinate origin O is indicated by r2.

In Example 2, the cylindrical screen 11 is defined by the inside of the cylindrical surface having a radius of 2 m with the origin O as the center position, and the ideal lens 13 has a focal length of 50 mm and an exit pupil diameter of 15 mm.

FIG. 12 is indicative of image distortions in Example 2. The outside, substantial quadrilateral stands for distortion at an image plane having the maximum image height, and the inside, substantial quadrilateral stands for distortion at an image plane of the maximum image height×0.7. It can be seen that the upper and lower sides of the substantial quadrilaterals draw close to horizontal, indicating that image distortions likely to be curved have been corrected.

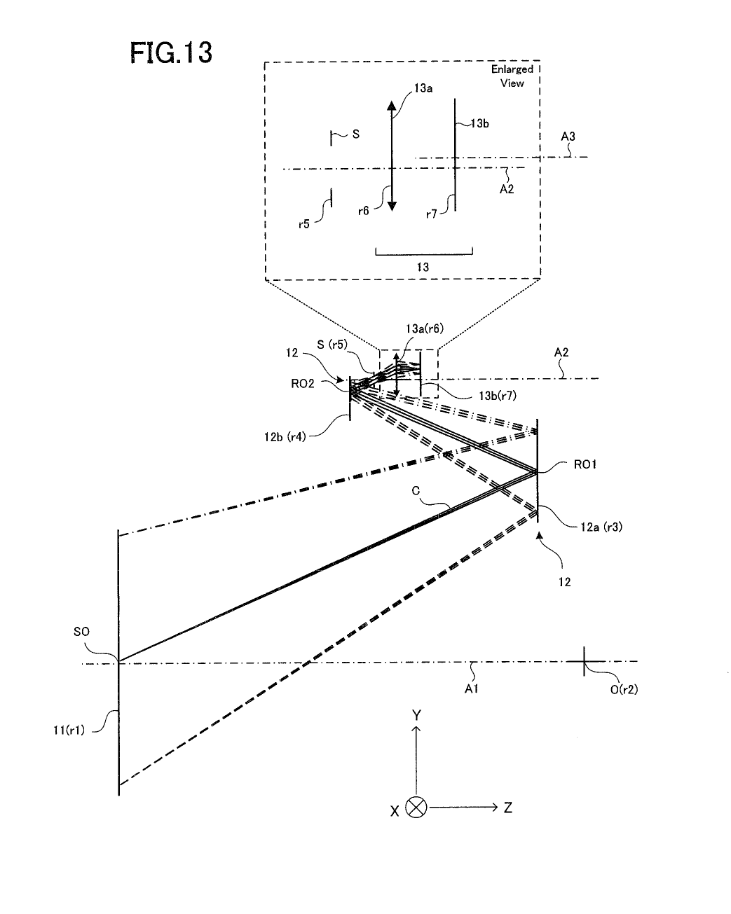

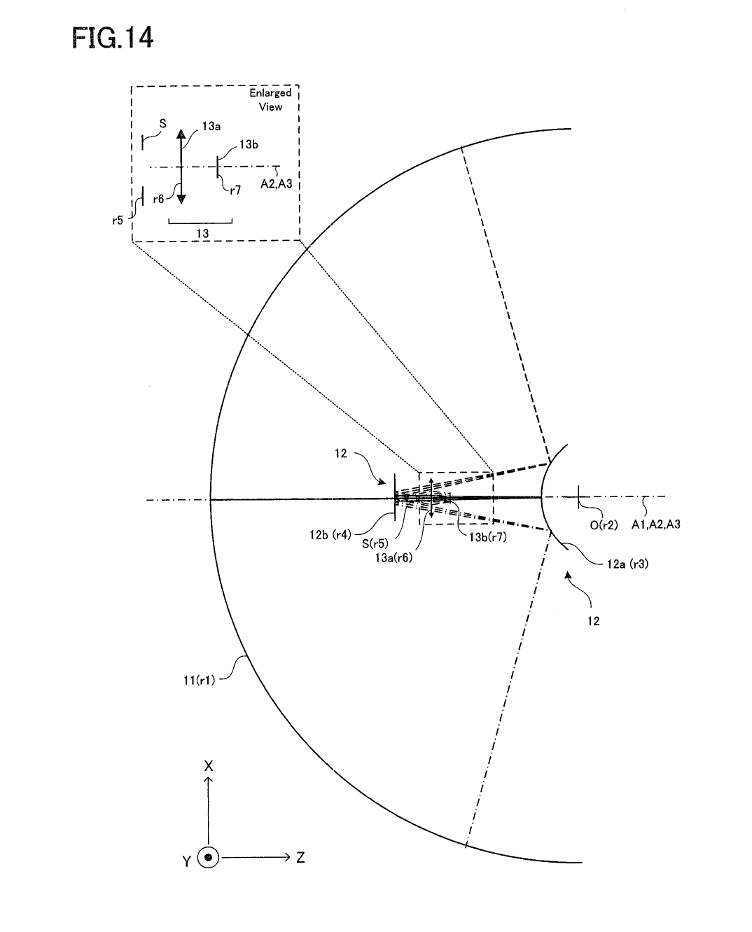

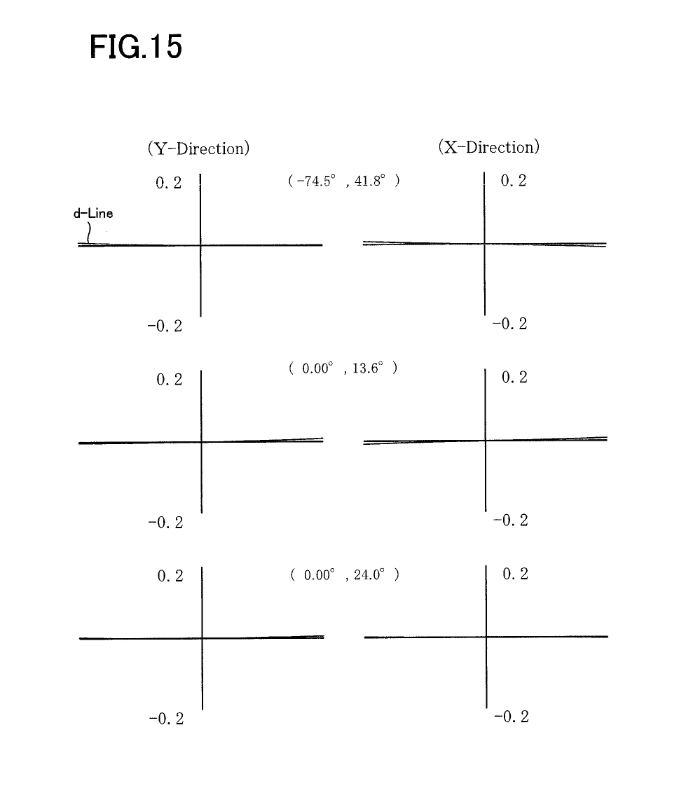

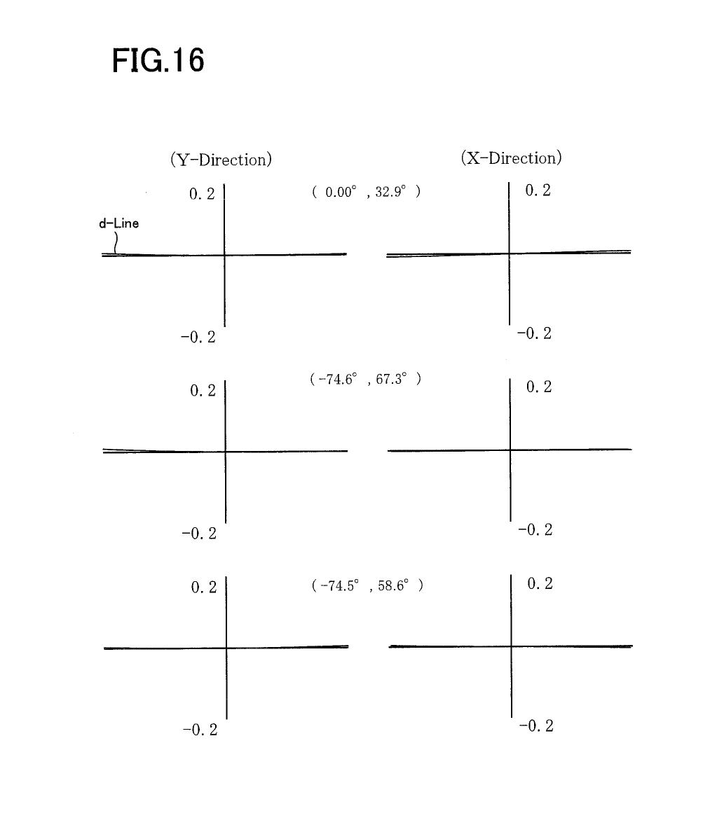

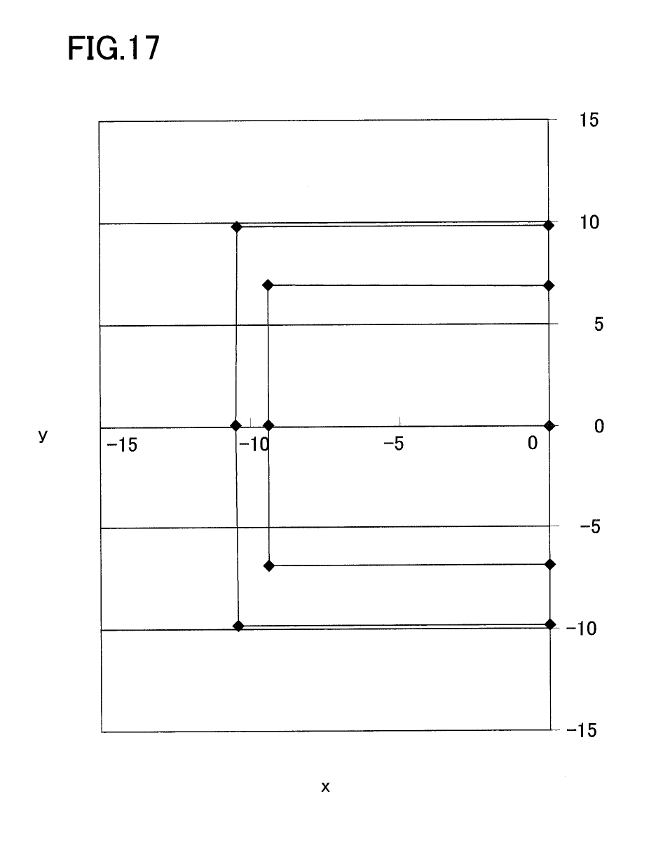

Example 3 is now explained. FIG. 13 is illustrative in the YZ plane section of the optical system of Example 3 and its peripherals, and FIG. 14 is illustrative on the ZX plane of the optical system of Example 3 and its peripherals. FIGS. 15 and 16 are transverse aberration diagrams for the whole optical system, and FIG. 17 is indicative of image distortions.

The projection optical apparatus of Example 3 is built up of a projection optical system 13 such as a projector for projecting an image displayed on a two-dimensional image display device 13b through an ideal lens 13a and a cylindrical screen 11 which is decentered with respect to the projection optical system 13 and onto which the image projected from the projection optical system 13 is projected, and further comprises a correction optical system 12 including a first optical device or a first free-form surface mirror 12a having different powers (refracting powers) in the direction (Y-axis direction) of the center axis of rotation 11a of the cylindrical screen 11 and in the direction (X-axis direction) that is orthogonal to a first surface 101 including the center chief ray C of a light beam traveling from the projection optical system 13 toward the cylindrical screen 11.

Further, the correction optical system 12 of Example 3 comprises a second optical device or a second free-form surface mirror 12b that is rotationally asymmetric about an optical axis A2 for correction of astigmatism occurring at the first free-form surface mirror 12a.

The cylindrical screen 11 is a reflecting surface that has a curvature in the ZX plane with the center axis of rotation 11a as center, and the first free-form surface mirror 12a is a rotationally asymmetric reflecting surface.

A line A1 that connects the center of projection SO of the cylindrical screen 11 with the coordinate origin O is decentered in the Y-axis direction with respect to the center axis A2 of the ideal lens 13a and image display device 13b in the projection optical system 13. Suppose here that the first center of reflection RO1 is defined by a point at which the center chief ray C is reflected off the cylindrical mirror 12a. The position of the first center of reflection RO1 in the Y-axis direction is then located between the line A1 and the center axis A2. Also suppose that the second center of reflection RO2 is defined by a point at which the center chief ray C is reflected at the second free-form surface mirror 12b. The position of the second center of reflection RO2 in the Y-axis direction is then located between the first center of reflection RO1 and the center axis A2. Consequently, an image projected from the projection optical system 13 obliquely onto the second free-form surface mirror 12b is reflected at the second free-form surface mirror 12b and then the first free-form surface mirror 12a and projected onto the cylindrical screen 11, providing a projected image that is viewed by the viewer.

Each of FIGS. 13 and 14 also presents an enlarged view of a site encircled by a broken line. The projection optical system 13 comprises an image display device 13b such as an LCD and an ideal lens 13a. A stop S is provided between the second free-form surface mirror 12b and the ideal lens 13a.

As shown in FIG. 13, the center axis A2 of the ideal lens 13a in the projection optical system 13 of Example 3 is decentered with respect to the center axis A3 of the image display device 13b. For this reason, an image emanating from the image display device 13b is projected through the periphery of the ideal lens 13a so that, just as is the case with use of a shift lens, it can be projected obliquely onto the decentered second free-form surface mirror 12b, and an image reflected at the second free-form surface mirror 12b is projected obliquely onto the first free-form surface mirror 12a.

Thus, oblique projection with the image display device 13b shifted and decentered is preferable because of no occurrence of distortions. Note here that with the projection optical system 13 tilted, there is a trapezoidal image distortion produced, but that may be electronically corrected.

Suppose here that the first free-form surface mirror 12a (reflecting surface) is used as the means for making the projection angle of view wide in the X-axis direction. However, the use of the first free-form surface mirror 12a would result in the occurrence of astigmatism, giving rise to deterioration of the image formed on the cylindrical screen 11. That astigmatism here is corrected using the second optical device comprising the second free-form surface mirror 12b.

At the time of back ray tracing, a light beam leaving the cylindrical screen 11 (r1) as an object surface is reflected at the first free-form surface mirror 12a (r3) and then the second free-form surface mirror 12b (r4) in the correction optical system 12, and enters the ideal lens 13a (r6) in the projection optical system 13 through the stop S (r5). Then, a light beam leaving the ideal lens 13a (r6) arrives at a radially given position off the optical axis of the image display device 13b (r7). Note here that the coordinate origin O is indicated by r2.

In Example 3, the cylindrical screen 11 is defined by the inside of the cylindrical surface having a radius of 1 m with the origin O as the center position, and the ideal lens 13 has a focal length of 50 mm and an exit pupil diameter of 15 mm.

FIG. 17 is indicative of image distortions in Example 3. The outside, substantial quadrilateral stands for distortion at an image plane having the maximum image height, and the inside, substantial quadrilateral stands for distortion at an image plane of the maximum image height×0.7. It can be seen that the upper and lower sides of the substantial quadrilaterals draw close to horizontal, indicating that image distortions likely to be curved have been corrected.

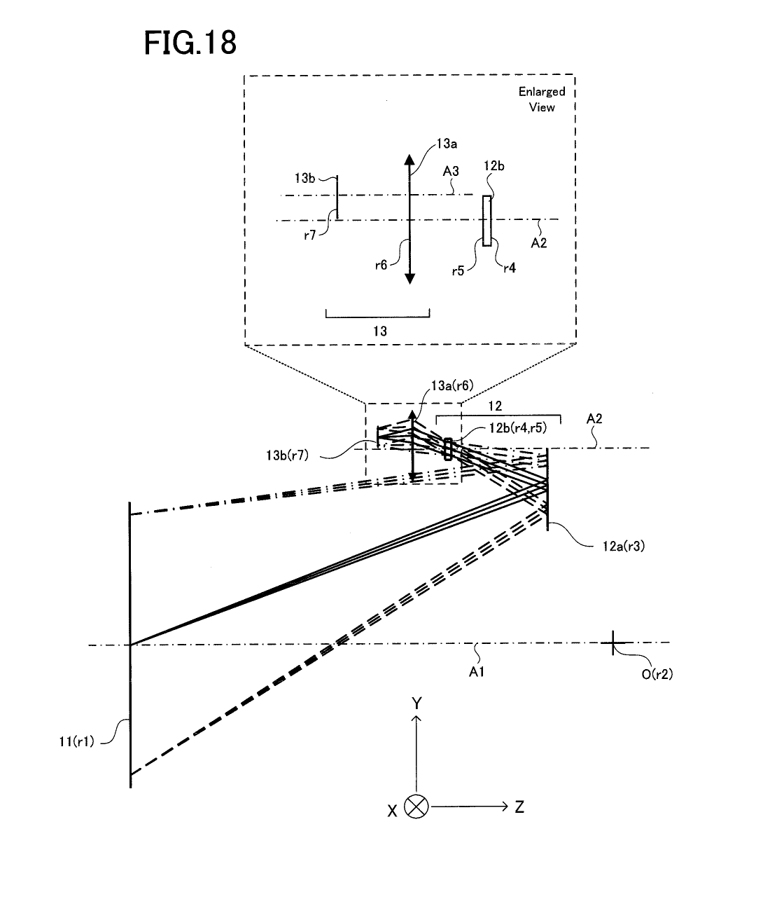

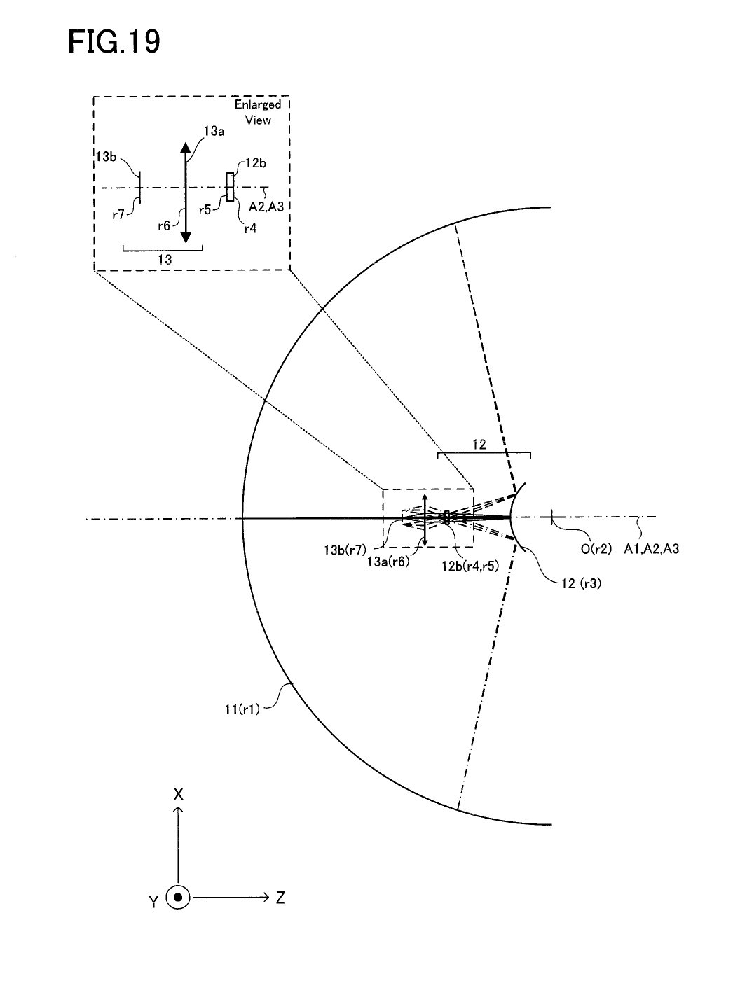

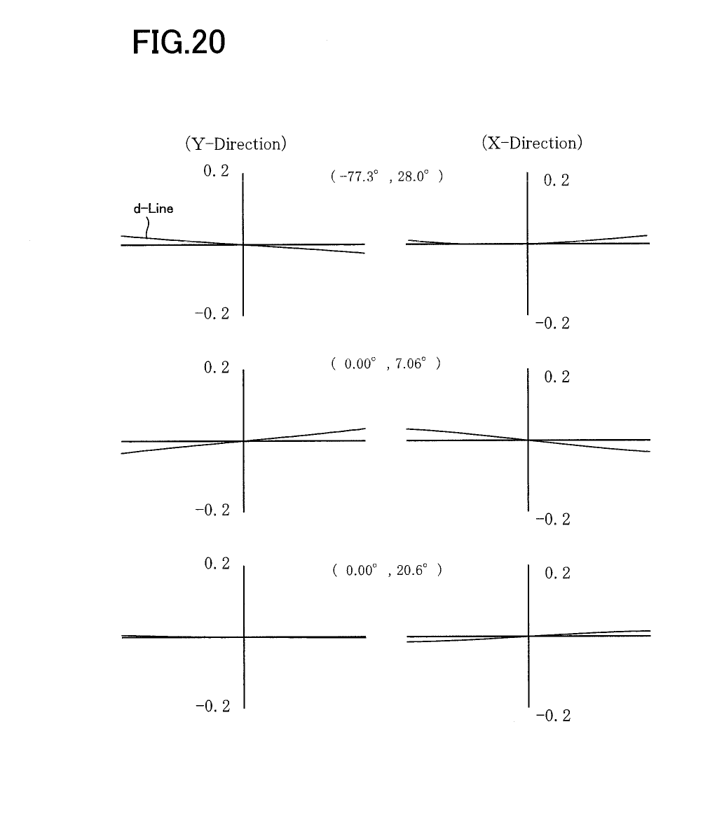

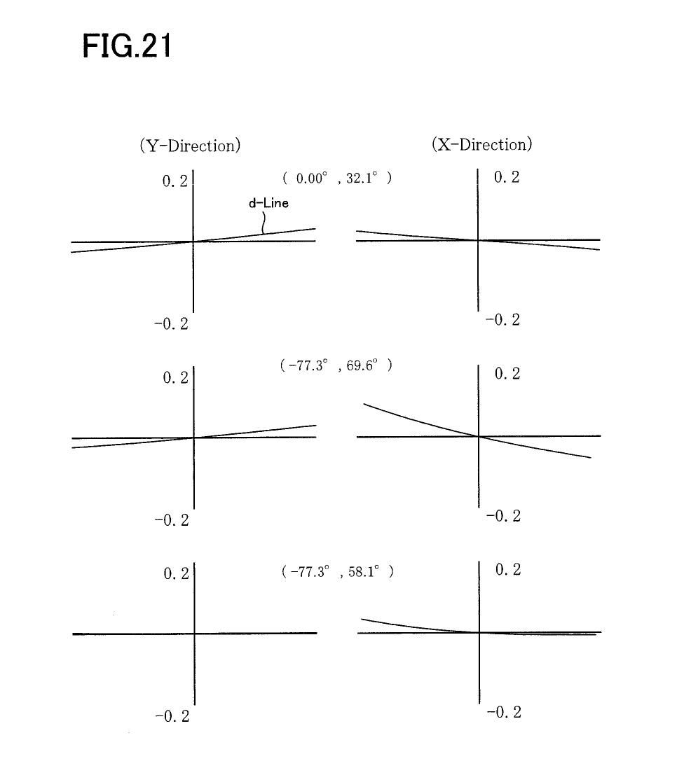

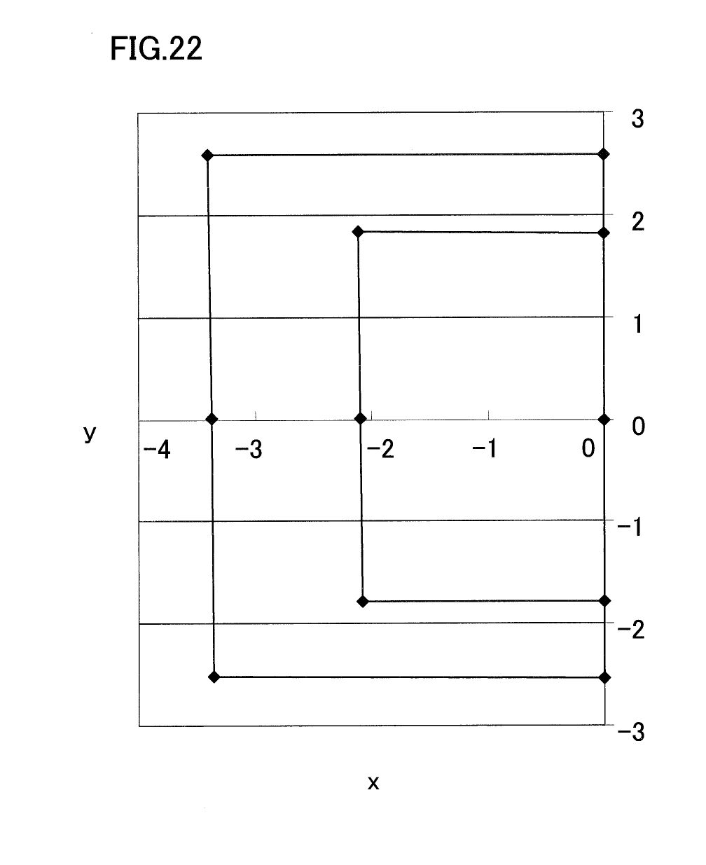

Example 4 is now explained. FIG. 18 is illustrative in the YZ plane section of the optical system of Example 4 and its peripherals, and FIG. 19 is illustrative on the ZX plane of the optical system of Example 4 and its peripherals. FIGS. 20 and 21 are transverse aberration diagrams for the whole optical system, and FIG. 22 is indicative of image distortions.

The projection optical apparatus of Example 4 is built up of a projection optical system 13 such as a projector for projecting an image displayed on a two-dimensional image display device 13b through an ideal lens 13a and a cylindrical screen 11 which is decentered with respect to the projection optical system 13 and onto which an image projected from the projection optical system 13 is projected, and further comprises a correction optical system 12 including a first optical device or cylindrical mirror 12a having different powers (refracting powers) in the direction (Y-axis direction) of the center axis of rotation 11a of the cylindrical screen 11 and in the direction (X-axis direction) that is orthogonal to a first surface 101 including the center chief ray C of a light beam traveling from the projection optical system 13 toward the cylindrical screen 11.

Further, the correction optical system 12 of Example 4 comprises a second optical device or cylindrical lens 12b that is rotationally asymmetric about an optical axis A2 for correction of astigmatism occurring at the cylindrical mirror 12a.

The cylindrical screen 11 is a reflecting surface that has a curvature in the ZX plane with the center axis of rotation 11a as center, and the cylindrical mirror 12a is a reflecting surface that is different in diametrical length from the cylindrical screen 11 and has a curvature in the ZX plane.

A line A1 that connects the center of projection SO of the cylindrical screen 11 with the coordinate origin O is decentered in the Y-axis direction with respect to the center axis A2 of the ideal lens 13a and the center axis A3 of the image display device 13b in the projection optical system 13. Suppose here that the center of reflection RO is defined by a point at which the center chief ray C is reflected off the cylindrical mirror 12a. The position of the center of reflection RO in the Y-axis direction is then located between the line A1 and the center axis A2 and between the line A1 and the center axis A3. Consequently, an image projected from the projection optical system 13 obliquely onto the cylindrical mirror 12a is reflected at the cylindrical mirror 12a and projected onto the cylindrical screen 11, providing a projected image that is viewed by the viewer.

Each of FIGS. 18 and 19 also presents an enlarged view of a site encircled by a broken line. The projection optical system 13 comprises an image display device 13b such as an LCD and an ideal lens 13a. The cylindrical lens 12b is provided with a stop at a cylindrical surface r4.

As shown in FIG. 18, the center axis A2 of the ideal lens 13a in the projection optical system 13 of Example 4 is decentered with respect to the center axis A3 of the image display device 13b. For this reason, an image emanating from the image display device 13b is projected through the periphery of the ideal lens 13a so that, just as is the case with use of a shift lens, it can be projected obliquely onto the decentered cylindrical mirror 12a.

Thus, oblique projection with the image display device 13b shifted and decentered is preferable because of no occurrence of distortions. Note here that with the projection optical system 13 tilted, there is a trapezoidal image distortion produced, but that may be electronically corrected.

Suppose here that the cylindrical mirror 12a (cylindrical reflecting surface) is used as the means for making the projection angle of view wide in the X-axis direction. However, the use of the cylindrical mirror 12a would result in the occurrence of astigmatism, giving rise to deterioration of the image formed on the cylindrical screen 11. That astigmatism here is corrected using the second optical device comprising the cylindrical lens 12b.

At the time of back ray tracing, a light beam leaving the cylindrical screen 11 as an object surface (r1) is reflected at the cylindrical mirror 12a (r3) in the correction optical system 12, and enters the cylindrical surface (r4) of the cylindrical lens 12b provided with the stop. Following this, a light beam transmitting through the cylindrical lens 12b and leaving the opposite surface (r5) enters the ideal long 13a (r6) in the projection optical system 13. Then, a light beam leaving the ideal lens 13a (r6) arrives at a radially given position off the optical axis of the image display device 13b (r7). Note here that the coordinate origin O is indicated by r2.

In Example 4, the cylindrical screen 11 is defined by the inside of the cylindrical surface having a radius of 15 cm with the origin O as the center position, and the ideal lens 13 has a focal length of 10 mm and an exit pupil diameter of 4 mm.

FIG. 22 is indicative of image distortions in Example 4. The outside, substantial quadrilateral stands for distortion at an image plane having the maximum image height, and the inside, substantial quadrilateral stands for distortion at an image plane of the maximum image height×0.7. It can be seen that the upper and lower sides of the substantial quadrilaterals draw close to horizontal, indicating that image distortions likely to be curved have been corrected.

Constituting parameters in Examples 1 to 4 are set out below. Note here that FFS in the following stands for a free-form surface.

### Example 1

| | Radius | | | | |
|---|---|---|---|---|---|
| Surface | of | Surface | | Refractive | Abbe |
| No. | Curvature | Separation | Decentration | Index | Constant |
| r1 | Cylindrical | 1000.00 | | | |
| | Surface | | | | |
| | [1] | | | | |

(Object Plane)

| | | |
|---|---|---|
| r2 | ∞ | 0.00 |

(Coordinate Origin)

| | | | | | |
|---|---|---|---|---|---|
| r3 | Cylindrical | 0.00 | Decentration | | |
| | Surface [2] | | (1) | | |
| r4 | Cylindrical | 0.00 | Decentration | 1.5163 | 64.1 |
| | Surface [3] | | (2) | | |
| (Stop) | | | | | |
| r5 | ∞ | 0.00 | Decentration | | |
| | | | (3) | | |
| r6 | Ideal Lens | 0.00 | Decentration | | |
| | | | (4) | | |
| r7 | ∞ | 0.00 | Decentration | | |
| | | | (5) | | |

(Image Plane)
Cylindrical Surface [1]

| | |
|---|---|
| X Direction Radius of Curvature | 1000.00 |
| Y Direction Radius of Curvature | ∞ |

Cylindrical Surface [2]

| | |
|---|---|
| X Direction Radius of Curvature | 416.73 |
| Y Direction Radius of Curvature | ∞ |

Cylindrical Surface [3]

| | |
|---|---|
| X Direction Radius of Curvature | −687.14 |
| Y Direction Radius of Curvature | ∞ |

Decentration [1]

| | | | | | |
|---|---|---|---|---|---|
| X | 0.00 | Y | 350.00 | Z | −300.00 |
| α | 0.00 | β | 0.00 | γ | 0.00 |

Decentration [2]

| | | | | | |
|---|---|---|---|---|---|
| X | 0.00 | Y | 500.00 | Z | −600.00 |
| α | 0.00 | β | 0.00 | γ | 0.00 |

Decentration [3]

| | | | | | |
|---|---|---|---|---|---|
| X | 0.00 | Y | 500.00 | Z | −605.00 |
| α | 0.00 | β | 0.00 | γ | 0.00 |

Decentration [4]

| | | | | | |
|---|---|---|---|---|---|
| X | 0.00 | Y | 500.00 | Z | −655.00 |
| α | 0.00 | β | 0.00 | γ | 0.00 |

Decentration [5]

| | | | | | |
|---|---|---|---|---|---|
| X | 0.00 | Y | 525.23 | Z | −708.41 |
| α | 0.00 | β | 0.00 | γ | 0.00 |

### Example 2

| | Radius | | | | |
|---|---|---|---|---|---|
| Surface | of | Surface | | Refractive | Abbe |
| No. | Curvature | Separation | Decentration | Index | Constant |
| r1 | Cylindrical | | | | |
| | Surface [1] | 2000.00 | | | |

(Object Plane)

| | | |
|---|---|---|
| r2 | ∞ | 0.00 |

(Coordinate Origin)

| | | | | | |
|---|---|---|---|---|---|
| r3 | Cylindrical | 0.00 | Decentration | | |
| | Surface [2] | | (1) | | |
| r4 | Cylindrical | 0.00 | Decentration | 1.5163 | 64.1 |
| | Surface [3] | | (2) | | |
| (Stop) | | | | | |
| r5 | ∞ | 0.00 | Decentration | | |
| | | | (3) | | |
| r6 | Ideal | 0.00 | Decentration | | |
| | Lens | | (4) | | |
| r7 | ∞ | 0.00 | Decentration | | |
| | | | (5) | | |

(Image Plane)
Cylindrical Surface [1]

| | |
|---|---|
| X Direction Radius of Curvature | 2000.00 |
| Y Direction Radius of Curvature | ∞ |

Cylindrical Surface [2]

| | |
|---|---|
| X Direction Radius of Curvature | 281.87 |
| Y Direction Radius of Curvature | ∞ |

Cylindrical Surface [3]

| | |
|---|---|
| X Direction Radius of Curvature | −362.10 |
| Y Direction Radius of Curvature | ∞ |

Decentration [1]

| | | | | | |
|---|---|---|---|---|---|
| X | 0.00 | Y | 595.00 | Z | −300.00 |
| α | 0.00 | β | 0.00 | γ | 0.00 |

Decentration [2]

| | | | | | |
|---|---|---|---|---|---|
| X | 0.00 | Y | 700.00 | Z | −600.00 |
| α | 0.00 | β | 0.00 | γ | 0.00 |

Decentration [3]

| | | | | | |
|---|---|---|---|---|---|
| X | 0.00 | Y | 700.00 | Z | −605.00 |
| α | 0.00 | β | 0.00 | γ | 0.00 |

Decentration [4]

| | | | | | |
|---|---|---|---|---|---|
| X | 0.00 | Y | 700.00 | Z | −655.00 |
| α | 0.00 | β | 0.00 | γ | 0.00 |

Decentration [5]

| | | | | | |
|---|---|---|---|---|---|
| X | 0.00 | Y | 717.53 | Z | −706.61 |
| α | 0.00 | β | 0.00 | γ | 0.00 |

### Example 3

| Surface No. | Radius of Curvature | Surface Separation | Decentration | Refractive Index | Abbe Constant |
|---|---|---|---|---|---|
| r1 | Cylindrical Surface [1] | 2000.00 | | | |

(Object Plane)

| | | |
|---|---|---|
| r2 | ∞ | 0.00 |

(Coordinate Origin)

| | | | | | |
|---|---|---|---|---|---|
| r3 | FFS [1] | 0.00 | Decentration (1) | | |
| r4 | FFS [2] | 0.00 | Decentration (2) | 1.5163 | 64.1 |
| (Stop) | | | | | |
| r5 | ∞ | 0.00 | Decentration (3) | | |
| r6 | Ideal Lens | 0.00 | Decentration (4) | | |
| r7 | ∞ | 0.00 | Decentration (5) | | |

(Image Plane)
Cylindrical Surface [1]

| | |
|---|---|
| X Direction Radius of Curvature | 1000.00 |
| Y Direction Radius of Curvature | ∞ |

FFS [1]

| | | | | | |
|---|---|---|---|---|---|
| C 4 | 2.5976E−003 | C 6 | 2.8258E−005 | C 8 | −1.0779E−007 |
| C 10 | 3.4901E−009 | C 11 | 4.6733E−008 | C 13 | 1.7474E−009 |

FFS [2]

| | | | | | |
|---|---|---|---|---|---|
| C 4 | 3.9474E−004 | C 6 | 8.9780E−005 | C 8 | −3.5485E−007 |
| C 10 | −1.2841E−007 | | | | |

Decentration [1]

| | | | | | |
|---|---|---|---|---|---|
| X | 0.00 | Y | 400.00 | Z | −100.00 |
| α | 0.00 | β | 0.00 | γ | 0.00 |

Decentration [2]

| | | | | | |
|---|---|---|---|---|---|
| X | 0.00 | Y | 577.78 | Z | −500.00 |
| α | 0.00 | β | 0.00 | γ | 0.00 |

Decentration [3]

| | | | | | |
|---|---|---|---|---|---|
| X | 0.00 | Y | 600.00 | Z | −450.00 |
| α | 0.00 | β | 0.00 | γ | 0.00 |

Decentration [4]

| | | | | | |
|---|---|---|---|---|---|
| X | 0.00 | Y | 600.00 | Z | −400.00 |
| α | 0.00 | β | 0.00 | γ | 0.00 |

Decentration [5]

| | | | | | |
|---|---|---|---|---|---|
| X | 0.00 | Y | 622.31 | Z | −348.73 |
| α | 0.00 | β | 0.00 | γ | 0.00 |

### Example 4

| | Radius | | | | |
|---|---|---|---|---|---|
| Surface | of | Surface | | Refractive | Abbe |
| No. | Curvature | Separation | Decentration | Index | Constant |
| r1 | Cylindrical | 150.00 | | | |
| | Surface | | | | |
| | [1] | | | | |

(Object Plane)

| | | |
|---|---|---|
| r2 | ∞ | 0.00 |

(Coordinate Origin)

| | | | | | |
|---|---|---|---|---|---|
| r3 | Cylindrical | 0.00 | Decentration | | |
| | Surface | | (1) | | |
| | [2] | | | | |
| r4 | Cylindrical | 0.00 | Decentration | 1.5163 | 64.1 |
| | Surface | | (2) | | |
| | [3] | | | | |
| (Stop) | | | | | |
| r5 | ∞ | 0.00 | Decentration | | |
| | | | (3) | | |
| r6 | Ideal | 0.00 | Decentration | | |
| | Lens | | (4) | | |
| r7 | ∞ | 0.00 | Decentration | | |
| | | | (5) | | |

(Image Plane)
Cylindrical Surface [1]

| | |
|---|---|
| X Direction Radius of Curvature | 150.00 |
| Y Direction Radius of Curvature | ∞ |

Cylindrical Surface [2]

| | |
|---|---|
| X Direction Radius of Curvature | 22.39 |
| Y Direction Radius of Curvature | ∞ |

Cylindrical Surface [3]

| | |
|---|---|
| X Direction Radius of Curvature | −34.97 |
| Y Direction Radius of Curvature | ∞ |

Decentration [1]

| | | | | | |
|---|---|---|---|---|---|
| X | 0.00 | Y | 48.76 | Z | −20.06 |
| α | 0.00 | β | 0.00 | γ | 0.00 |

Decentration [2]

| | | | | | |
|---|---|---|---|---|---|
| X | 0.00 | Y | 60.00 | Z | −50.00 |
| α | 0.00 | β | 0.00 | γ | 0.00 |

Decentration [3]

| | | | | | |
|---|---|---|---|---|---|
| X | 0.00 | Y | 60.00 | Z | −52.00 |
| α | 0.00 | β | 0.00 | γ | 0.00 |

Decentration [4]

| | | | | | |
|---|---|---|---|---|---|
| X | 0.00 | Y | 60.00 | Z | −62.00 |
| α | 0.00 | β | 0.00 | γ | 0.00 |

Decentration [5]

| | | | | | |
|---|---|---|---|---|---|
| X | 0.00 | Y | 63.76 | Z | −72.79 |
| α | 0.00 | β | 0.00 | γ | 0.00 |

Tabulated below are of the angle α of the center chief ray incident onto the cylindrical screen as well as the values of Conditions (1) and (2) in Examples 1 to 4.

| | Example 1 | Example 2 | Example 3 | Example 4 |
|---|---|---|---|---|
| α | 26.57 | 19.29 | 23.75 | 20.57 |
| (1) Rr | 416.73 | 281.87 | 192.49 | 22.39 |
| (2) Rs/Rr | 2.40 | 7.10 | 5.20 | 6.70 |

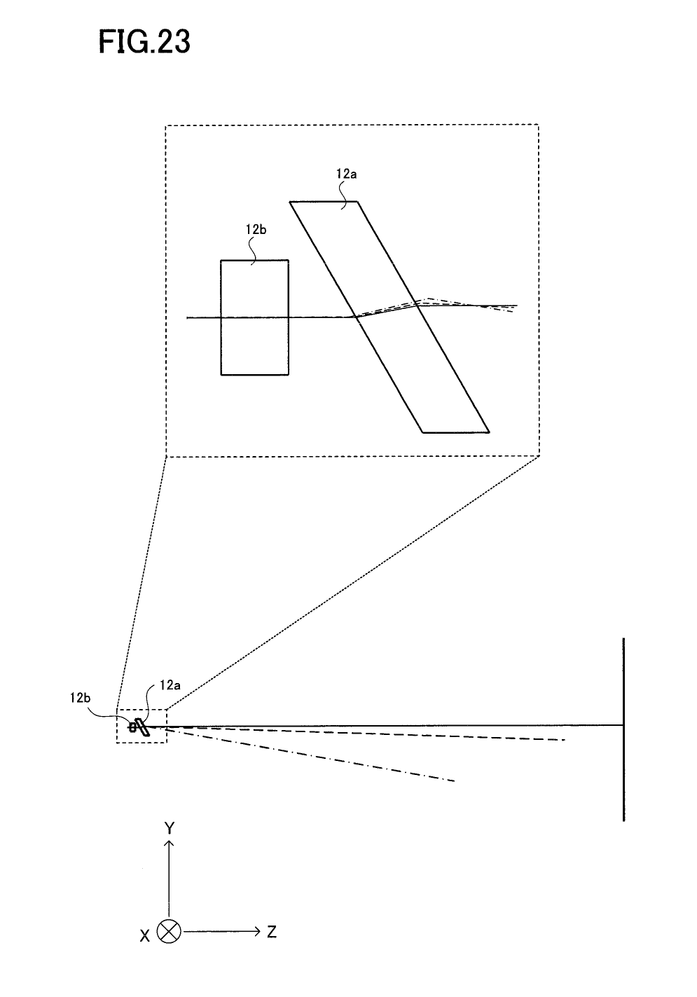

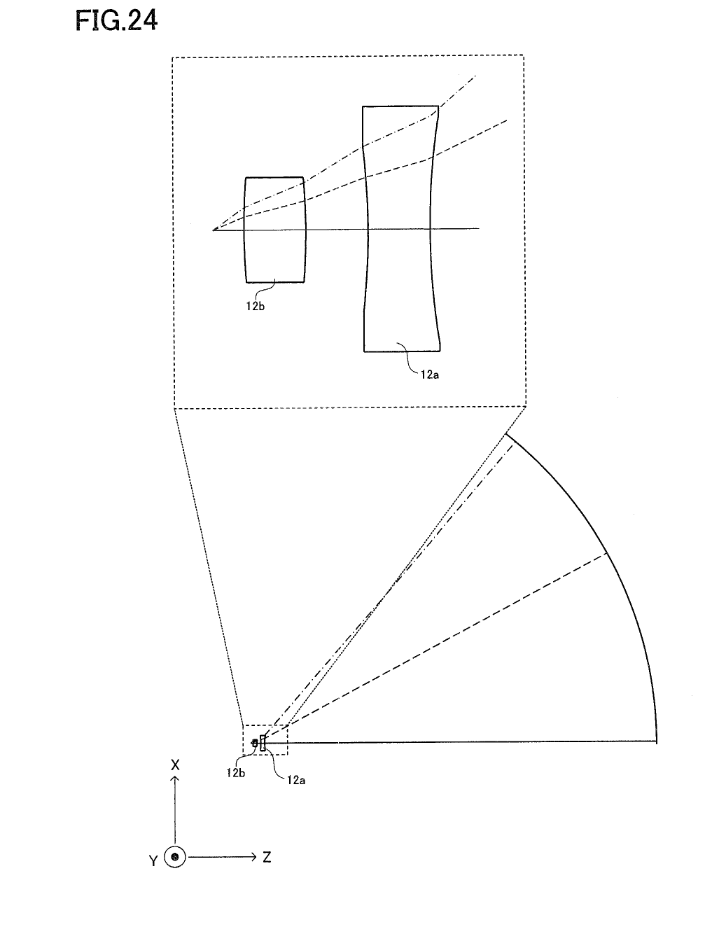

FIGS. 23 and 24 are illustrative of other examples.

For instance, the direction of the first cylindrical lens 12a having no power is defined as the Y-axis direction, and the direction having power is defined as the X-axis direction. Suppose here that the cylindrical lens 12 is decentered with an axis of tilting set in the X-axis direction. Then there is distortion occurring that leaves the projection image plane curved. With this image distortion it would also be possible to correct curved image distortion occurring in the case of oblique projection onto the cylindrical screen.

Wherever there is a cylindrical lens having a negative sign with respect to the projection optical system, it is preferable that the direction of tilting is set in the same direction as the cylindrical screen. With a positive cylindrical lens, it is preferable that the direction of tilting is set in the opposite direction.

In view of the fact that astigmatism occurs at the first cylindrical lens 12a, there is a need for providing an optical device for correction of that astigmatism. That astigmatism may be corrected with the second cylindrical lens 12b that has the same power but a different sign.

More preferably, positive and negative cylindrical lenses should be decentered in such opposite directions to have a katakana [symbol] shape upon viewed from the X-axis direction as the axis of tilting. This is because large curved image distortion is produced in such a way as to be compatible with oblique projection at an acute angle.

More preferably, the amount of tilting should be variable so as to be well compatible with any desired curved image distortion.

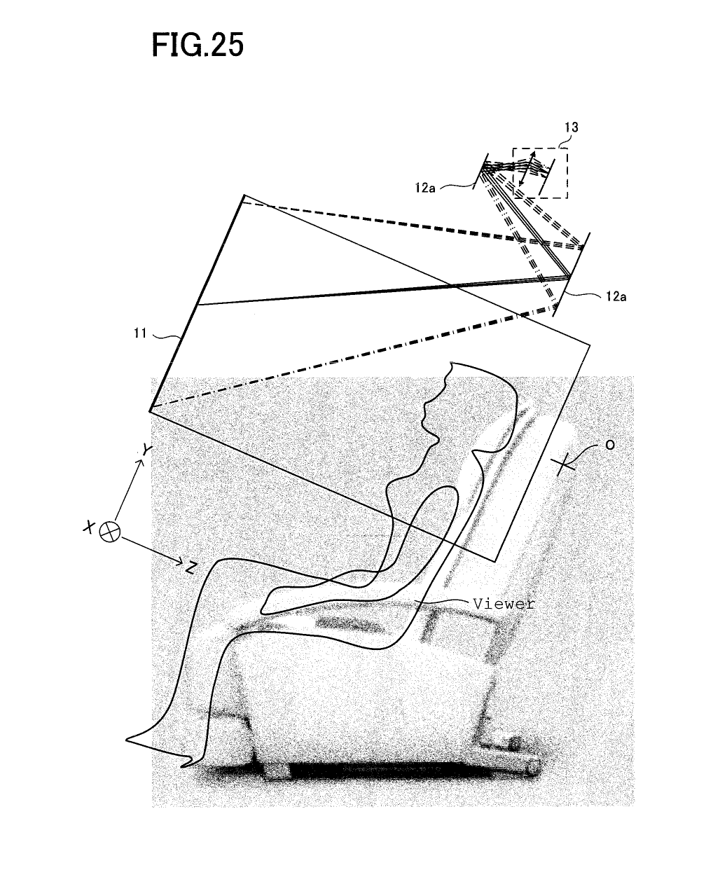

FIG. 25 is illustrative in the YZ plane section of the optical system according to a further embodiment and its peripherals as well as how the projected image is viewed by the viewer.

The same as in Example 3 explained with reference to FIG. 13 applies to arrangements and light rays. In the apparatus here, the projected image is viewed by a viewer who is seated typically as shown. For viewing, it is preferable that with the viewer seated in place, the direction of line of sight is along the Z-axis. Thus, if the projection optical system 13 such as a projector and the correction optical system 12 are each movable in such a way as to be variable in position depending on what state the viewer is seated in, it is then possible to offer an easy-to-view projected image depending on what state the viewer is seated in. When a reclining or other tilting seat is used, the whole apparatus may be designed in such a way as to tilt depending on the angle of reclining.

Thus, with the optical system according to the embodiment here, it is possible to offer a projected image in which the viewer gets oneself absorbed, while seated or otherwise positioned. In addition, it is possible to project onto the cylindrical screen 11a high-resolution projection image that has reduced distortion and is in focus all over the surface.

While the invention has been described with reference to several embodiments, it is to be understood that the invention is never limited to them, and any combinations of them are included in the invention.

What is claimed is:

1. A projection optical apparatus, comprising:
a projection optical system for projection of an image displayed on a two-dimensional image display device;
a cylindrical screen which is decentered with respect to the projection optical system and onto which an image projected from the projection optical system is projected; and
a correction optical system that comprises an optical device having different powers in a direction (Y-axis direction) of a center axis of rotation of the cylindrical screen and in a direction (X-axis direction) orthogonal to a first plane including a center chief ray of a light beam traveling from the projection optical system toward the cylindrical screen.

2. The projection optical system as recited in claim 1, wherein the optical device having different powers in the X-axis and Y-axis directions is a cylindrical mirror.

3. The projection optical system as recited in claim 1, wherein the correction optical system comprises a first optical device having different powers in the Y-axis and X-axis directions, and a second optical device that is rotationally asymmetric about an optical axis for correction of astigmatism produced at the first optical device.

4. The projection optical apparatus as recited in claim 1, wherein the cylindrical screen has an arc angle of 30° or greater.

5. The projection optical apparatus as recited in claim 1, wherein a center chief ray to be projected onto a center of projection on the cylindrical screen has an angle of 10° or greater.

6. The projection optical apparatus as recited in claim 1, which satisfies the following Condition (1):
Rr<500 (1)
where Rr is a radius of curvature of a cylindrical mirror in a horizontal direction.

7. The projection optical apparatus as recited in claim 1, which satisfies the following Condition (2):
2<Rs/Rr (2)
where Rs is a radius of curvature of the screen,
and Rr is a radius of curvature of a cylindrical mirror in a horizontal direction.
